(19) United States
(12) Patent Application Publication
(10) Pub. No.: US 2024/0248543 A1
(43) Pub. Date: Jul. 25, 2024

(54) GESTURE CONTROL OF A DEVICE

(71) Applicant: QUALCOMM Incorporated, San Diego, CA (US)

(72) Inventors: Roberto RIMINI, San Diego, CA (US); Anant GUPTA, San Diego, CA (US); Udara FERNANDO, San Diego, CA (US)

(21) Appl. No.: 18/158,771

(22) Filed: Jan. 24, 2023

(51) Int. Cl. G06F 3/01; H04M 1/72403; H04M 1/72448; H04M 1/72484

(52) U.S. Cl. CPC G06F 3/017; H04M 1/72403; H04M 1/72448; H04M 1/72484

(57) ABSTRACT

In some aspects, a device may detect an occurrence of an event associated with the device. The device may transmit a transmission signal responsive to detecting the occurrence of the event. The device may receive a reception signal that is a reflection of the transmission signal from an object. The device may determine, using at least the reception signal, a characteristic of a movement of the object. The device may determine that the characteristic of the movement is indicative of a gesture designated for controlling a function of the device. The device may control the function of the device responsive to determining that the characteristic of the movement is indicative of the gesture. Numerous other aspects are described.

### FIELD OF THE DISCLOSURE

Aspects of the present disclosure generally relate to object detection and, for example, to gesture control of a device.

### BACKGROUND

A radar device is a type of sensor that may be used to detect a target, determine characteristics of the target, or the like. A radar device may be used in a user device to detect the presence of humans in proximity of the user device. If a human is detected in proximity of the user device, the user device may adjust a transmission power of the user device to comply with a maximum permissible exposure standard.

### SUMMARY

Some aspects described herein relate to a device. The device may include a detection system, one or more memories, and one or more processors coupled to the one or more memories. The one or more processors may be configured to detect an occurrence of an event associated with the device. The one or more processors may be configured to activate the detection system responsive to detecting the occurrence of the event, where activating the detection system is to cause transmission of a transmission signal, and reception of a reception signal that is a reflection of the transmission signal from an object. The one or more processors may be configured to determine, using at least the reception signal, a characteristic of a movement of the object. The one or more processors may be configured to determine that the characteristic of the movement is indicative of a gesture designated for controlling a function of the device. The one or more processors may be configured to control the function of the device responsive to determining that the characteristic of the movement is indicative of the gesture.

Some aspects described herein relate to a method. The method may include detecting, by a device, an occurrence of an event associated with the device. The method may include transmitting, by the device, a transmission signal responsive to detecting the occurrence of the event. The method may include receiving, by the device, a reception signal that is a reflection of the transmission signal from an object. The method may include determining, by the device and using at least the reception signal, a characteristic of a movement of the object. The method may include determining, by the device, that the characteristic of the movement is indicative of a gesture designated for controlling a function of the device. The method may include controlling, by the device, the function of the device responsive to determining that the characteristic of the movement is indicative of the gesture.

Some aspects described herein relate to a non-transitory computer-readable medium that stores a set of instructions. The set of instructions, when executed by one or more processors of a device, may cause the device to detect an occurrence of an event associated with the device. The set of instructions, when executed by one or more processors of the device, may cause the device to activate a detection system responsive to detecting the occurrence of the event, where activating the detection system is to cause transmission of a transmission signal, and reception of a reception signal that is a reflection of the transmission signal from an object. The set of instructions, when executed by one or more processors of the device, may cause the device to determine, using at least the reception signal, a characteristic of a movement of the object. The set of instructions, when executed by one or more processors of the device, may cause the device to determine that the characteristic of the movement is indicative of a gesture designated for controlling a function of the device. The set of instructions, when executed by one or more processors of the device, may cause the device to control the function of the device responsive to determining that the characteristic of the movement is indicative of the gesture.

Some aspects described herein relate to an apparatus. The apparatus may include means for detecting an occurrence of an event. The apparatus may include means for transmitting a transmission signal responsive to detecting the occurrence of the event. The apparatus may include means for receiving a reception signal that is a reflection of the transmission signal from an object. The apparatus may include means for determining, using at least the reception signal, a characteristic of a movement of the object. The apparatus may include means for determining that the characteristic of the movement is indicative of a gesture designated for controlling a function. The apparatus may include means for controlling the function responsive to determining that the characteristic of the movement is indicative of the gesture.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of a device, in accordance with the present disclosure.

FIGS. 3A-3G are diagrams illustrating an example associated with gesture control of a device, in accordance with the present disclosure.

FIG. 4 is a diagram illustrating an example associated with gesture control of a device, in accordance with the present disclosure.

FIG. 5 is a flowchart of an example process associated with gesture control of a device.

FIG. 6 is a flowchart of an example process associated with gesture control of a device.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A user device, such as a smartphone, may provide functionality for setting an alarm, placing and receiving phone calls, playing media, or the like. In general, this functionality may operate in connection with a user interface presented on a display of the user device. For example, in connection with an alarm activating on the user device, the user device may present, on the display, a user interface with controls that enable a user to stop the alarm, snooze the alarm, and/or reset the alarm. As another example, in connection with an incoming phone call to the user device, the user device may present, on the display, a user interface with controls that enable a user to answer the call, decline the call, and/or mute a ringtone.

In some cases, the user may be unable to interact with a user interface on the display of the user device, or it may be difficult for the user to do so. For example, if an alarm activates on the user device while the user is sleeping, the user may be slow to react and/or may fumble with the user device while attempting to use the user interface. In other cases, the user may be cooking, cleaning, or performing another activity where the user does not wish to touch the user device in order to interact with the user interface. Moreover, the user device may consume excessive power in connection with presenting the user interface on the display, thereby depleting a battery of the user device. This may be exacerbated when the user is slow to, or unable to, interact with the user interface. In some examples, control of the user device may be performed using mechanical buttons of the user device. However, it may be difficult for the user to locate the mechanical buttons in low-light environments.

Some aspects described herein enable control of a user device using gestures (e.g., touchless control). The user device may include a detection system, such as a radar system. The user device may use the detection system to detect a non-stationary object, determine a characteristic (e.g., a velocity) of a movement of the non-stationary object, and determine whether the characteristic of the movement is indicative of a gesture designated for controlling a function of the user device. That is, the user device may use the detection system to perform gesture recognition. For example, the gesture may be designated for deactivating an alarm of the user device, silencing a ringtone of the user device, declining an incoming call to the user device, and/or adjusting a volume of the user device, among other examples. In some aspects, the user device may activate the detection system responsive to detecting an occurrence of an event associated with the user device, such as activation of an alarm of the user device or an incoming call to the user device. In this way, power that may have otherwise been consumed by constant operation of the detection system may be conserved.

Gesture control of the function of the user device may facilitate faster control of the function relative to control through a user interface presented on a display of the user device. Accordingly, the gesture control may reduce an amount of time that the display of the user device is illuminated, thereby conserving power and extending a battery life of the user device. In some aspects, the user device may refrain from activating the display of the user device when the detection system is being used to detect the gesture, thereby providing significant power saving.

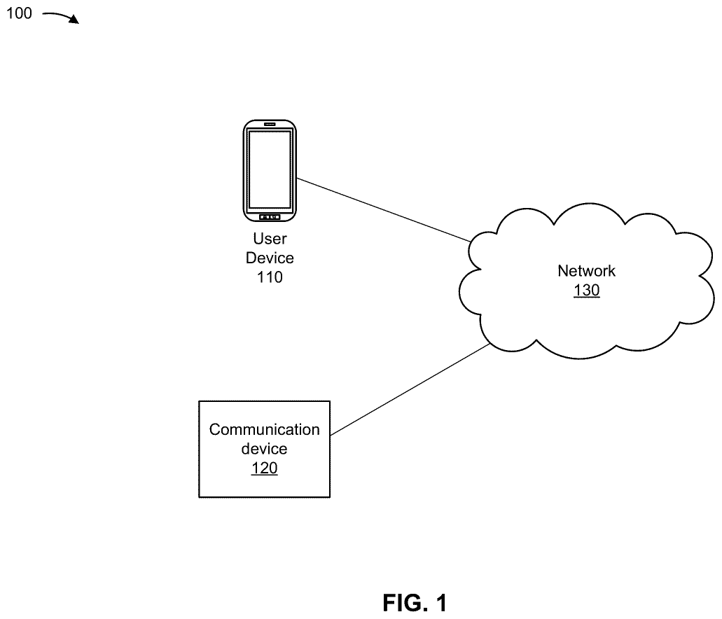

FIG. 1 is a diagram of an example environment 100 in which systems and/or methods described herein may be implemented. As shown in FIG. 1, environment 100 may include a user device 110, a communication device 120, and a network 130. Devices of environment 100 may interconnect via wired connections, wireless connections, or a combination of wired and wireless connections.

The user device 110 may include one or more devices capable of receiving, generating, storing, processing, and/or providing information associated with gesture control, as described elsewhere herein. The user device 110 may include a communication device and/or a computing device. For example, the user device 110 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The communication device 120 may include one or more devices capable of placing calls to the user device 110 and/or providing media to the user device 110, among other examples, as described elsewhere herein. The communication device 120 may include a communication device and/or a computing device. For example, the communication device 120 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a server, such as an application server, a client server, a web server, a database server, a host server, a proxy server, a virtual server (e.g., executing on computing hardware), or a server in a cloud computing system. In some aspects, the communication device 120 may include computing hardware used in a cloud computing environment.

The network 130 may include one or more wired and/or wireless networks. For example, the network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 130 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

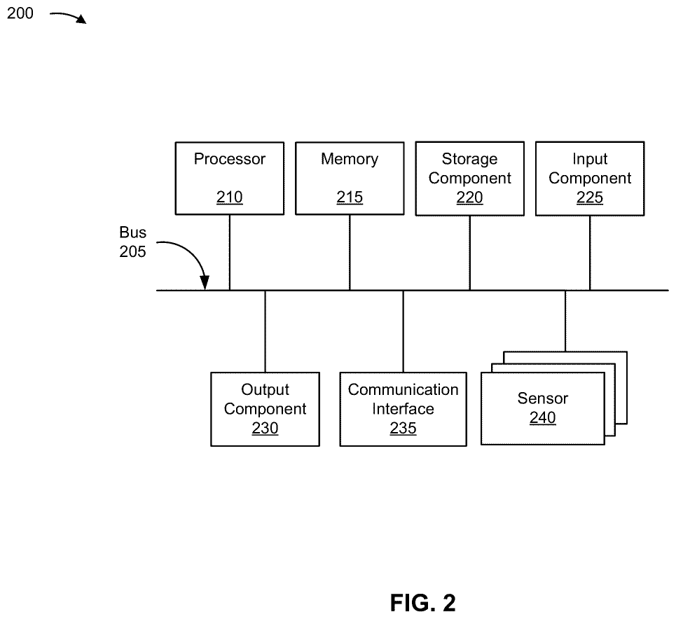

FIG. 2 is a diagram illustrating example components of a device 200, in accordance with the present disclosure. Device 200 may correspond to user device 110 and/or communication device 120. In some aspects, user device 110 and/or communication device 120 may include one or more devices 200 and/or one or more components of device 200. As shown in FIG. 2, device 200 may include a bus 205, a processor 210, a memory 215, a storage component 220, an input component 225, an output component 230, a communication interface 235, and/or one or more sensors 240.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

Sensor 240 includes one or more devices capable of detecting a characteristic associated with device 200 (e.g., a characteristic relating to a physical environment of the device 200 or a characteristic relating to a condition of the device 200). Sensor 240 may include one or more photodetectors (e.g., one or more photodiodes), one or more cameras, one or more microphones, one or more gyroscopes (e.g., a micro-electro-mechanical system (MEMS) gyroscope), one or more magnetometers, one or more accelerometers, one or more location sensors (e.g., a GPS receiver or a local position system (LPS) device), one or more motion sensors, one or more temperature sensors, one or more pressure sensors, and/or one or more touch sensors, among other examples. In some aspects, sensor 240 may include a detection system, such as a radar system, a lidar system, an ultrasonic detection system, or the like.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, device 200 may include means for detecting an occurrence of an event; means for activating a detection system responsive to detecting the occurrence of the event, where activating the detection system is to cause transmission of a transmission signal, and reception of a reception signal that is a reflection of the transmission signal from an object; means for determining, using at least the reception signal, a characteristic of a movement of the object; means for determining that the characteristic of the movement is indicative of a gesture designated for controlling a function; and/or means for controlling the function responsive to determining that the characteristic of the movement is indicative of the gesture. As another example, device 200 may include means for detecting an occurrence of an event; means for transmitting a transmission signal responsive to detecting the occurrence of the event; means for receiving a reception signal that is a reflection of the transmission signal from an object; means for determining, using at least the reception signal, a characteristic of a movement of the object; means for determining that the characteristic of the movement is indicative of a gesture designated for controlling a function; and means for controlling the function responsive to determining that the characteristic of the movement is indicative of the gesture. In some aspects, such means may include one or more components of device 200 described in connection with FIG. 2, such as bus 205, processor 210, memory 215, storage component 220, input component 225, output component 230, communication interface 235, and/or sensor(s) 240.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

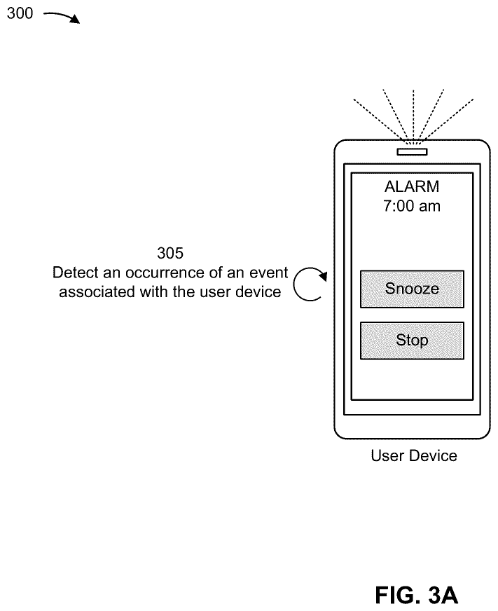

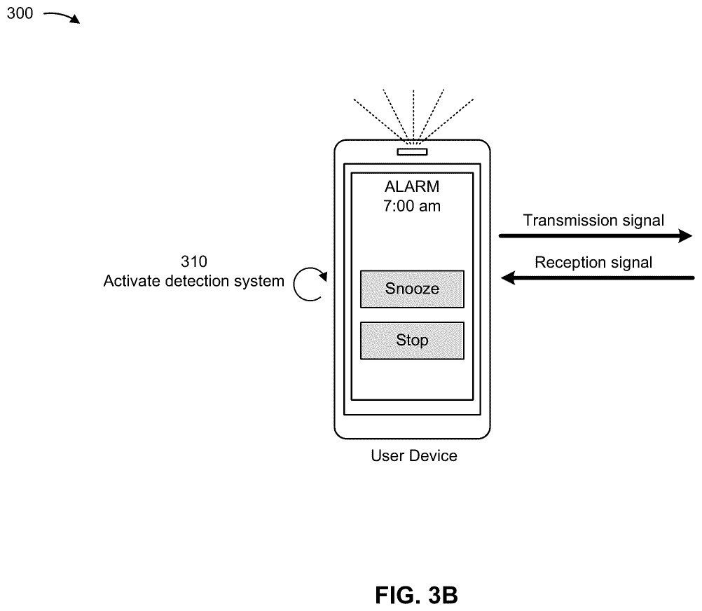

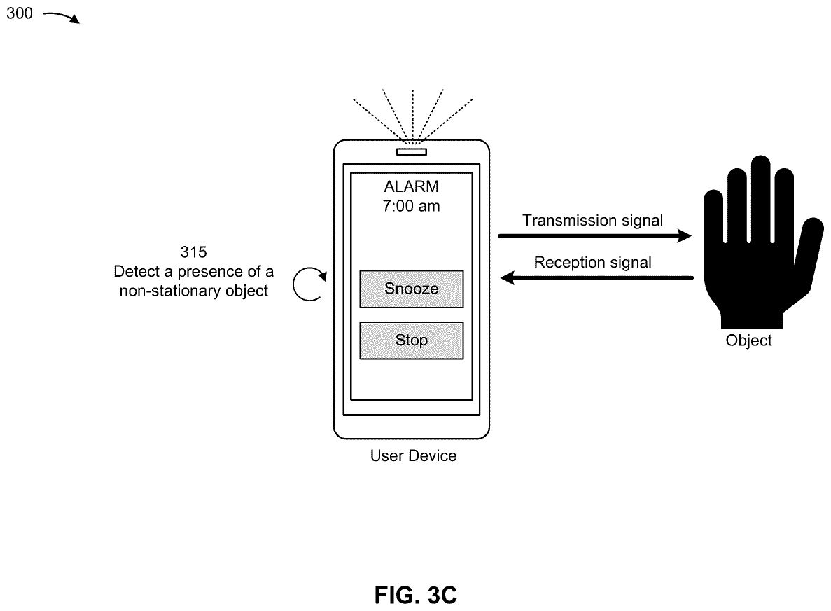

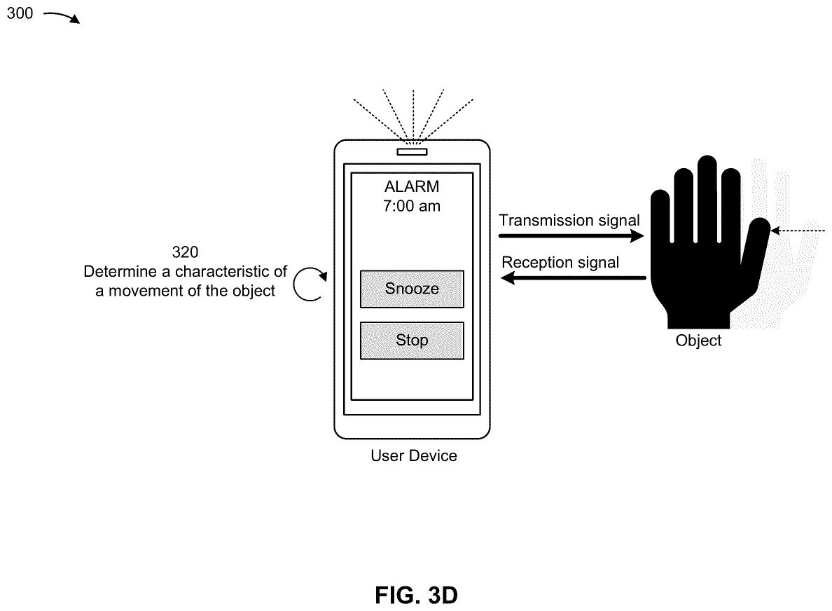

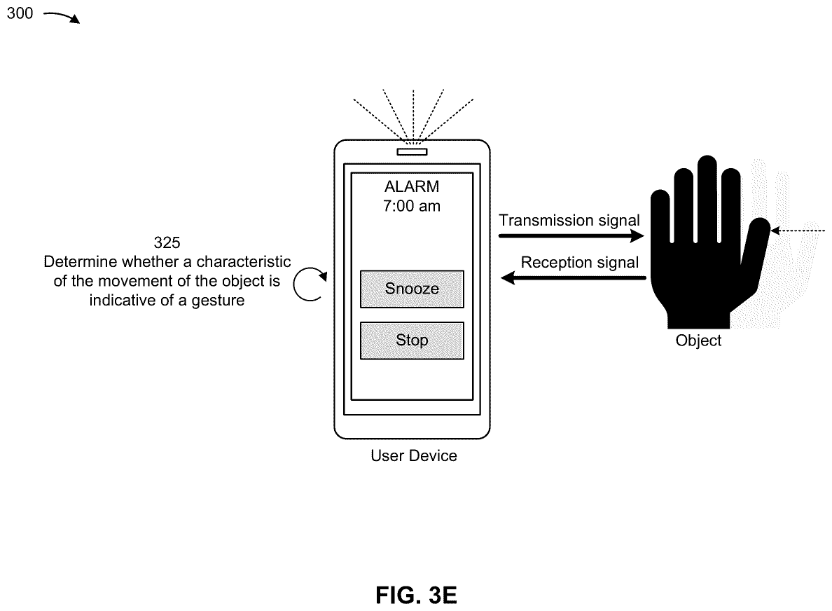

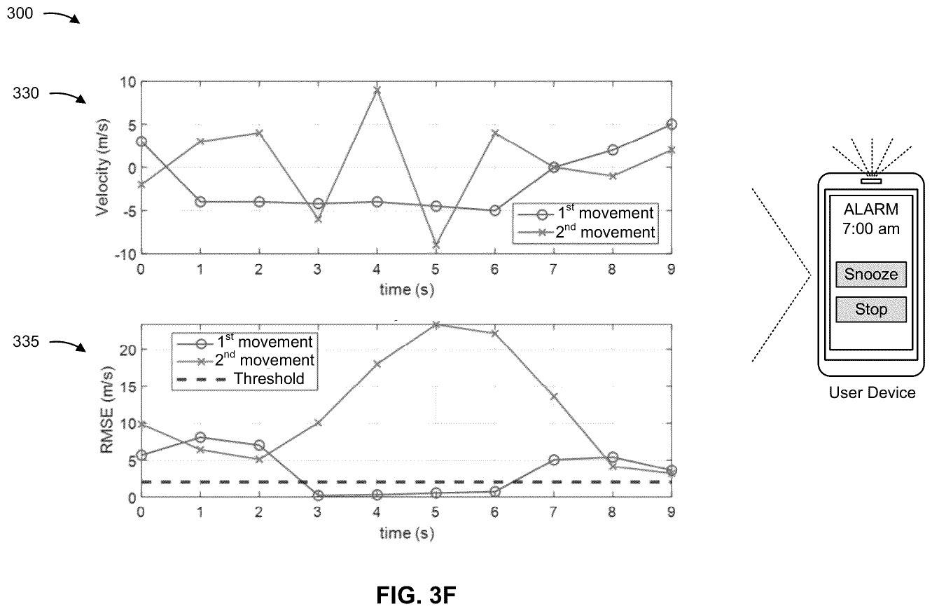

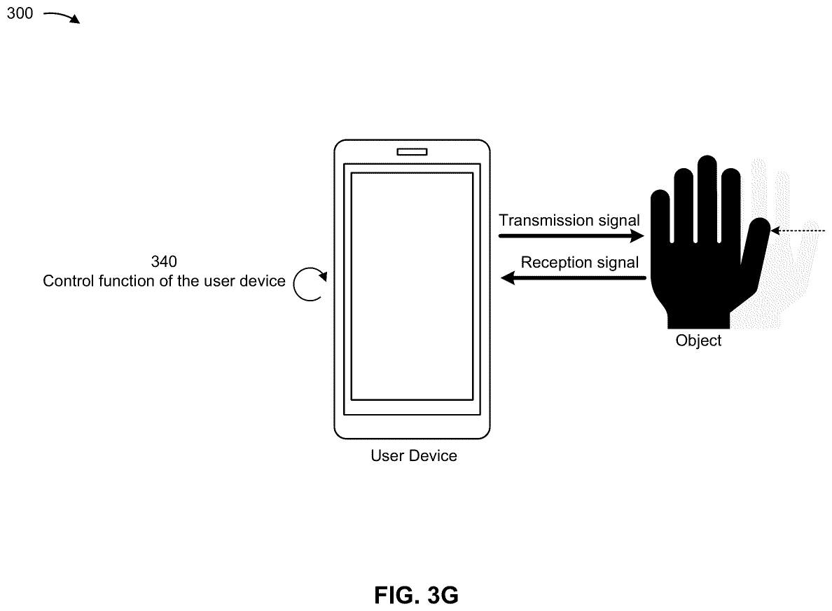

FIGS. 3A-3G are diagrams illustrating an example 300 associated with gesture control of a device, in accordance with the present disclosure. As shown in FIGS. 3A-3G, example 300 includes a user device (e.g., user device 110). The user device may include a detection system. The detection system may include a transmitter (e.g., one or more transmitters) and a receiver (e.g., one or more receivers). That is, the detection system may include a transceiver. The detection system may include a radar system, a lidar system, and/or an ultrasound detection system, among other examples. For example, the detection system may be configured for frequency modulated continuous wave (FMCW) operation, unmodulated continuous wave operation, pulsed operation, or the like.

As shown in FIG. 3A, and by reference number 305, the user device may detect an occurrence of an event associated with the user device. For example, the event may be one that is to cause the user device to activate the detection system of the user device. As an example, the event may be an alarm of the user device activating (e.g., in connection with an alarm clock function of the user device, a timer function of the user device, or the like), an incoming call to the user device (e.g., a voice call or a video call), an incoming message to the user device (e.g., a text message, an email message, or a chat message), and/or media (e.g., audio media, video media, gaming media, or the like) playing on the user device, among other examples.

In some aspects, detecting the occurrence of the event may include detecting that the event is presently occurring (e.g., an incoming call has been received at the user device) or detecting that the event is to occur in the future (e.g., an alarm of the user device has been set for a future time). In some aspects, the user device may detect the occurrence of the event according to information provided by one or more applications of the user device to the user device (e.g., to an operating system of the user device). For example, an alarm application of the user device may provide information, indicating a time at which the alarm is to be activated, to the user device (e.g., to the operating system of the user device).

As shown in FIG. 3B, and by reference number 310, the user device may activate the detection system. The user device may activate the detection system responsive to detecting the occurrence of the event. For example, responsive to detecting that the event is presently occurring (e.g., an incoming call has been received at the user device), the user device may activate the detection system. As another example, responsive to detecting that the event is to occur at a future time (e.g., an alarm of the user device has been set for a future time), the user device may activate the detection system at the future time. In some aspects, the user device may activate the detection system responsive to a battery level of the user device satisfying a threshold (e.g., the battery level being above the threshold), and the user device may refrain from activating the detection system responsive to the battery level not satisfying the threshold. Activating the detection system may cause transmission of a transmission signal (e.g., by the transmitter of the detection system), and may cause reception of a reception signal (e.g., by the receiver of the detection system) that is a reflection of the transmission signal from an object (e.g., a reflected echo of the transmission signal from a target). Stated differently, the user device may transmit (e.g., using the transmitter of the detection system) the transmission signal (e.g., the user device may transmit one or more transmission signals from respective transmitters of the detection system) responsive to detecting the occurrence of the event. In addition, the user device may receive (e.g., using the receiver of the detection system) the reception signal (e.g., the user device may receive one or more reception signals at respective receivers of the detection system) that is a reflection of the transmission signal from an object.

In some aspects, the object may be a non-stationary object. For example, the object may be a user of the user device (e.g., a human), such as a body part (e.g., a hand) of the user. In some aspects, the transmission signal and the reception signal may be radio signals (e.g., when the detection system includes a radar system). In some aspects, the transmission signal and the reception signal may be optical signals (e.g., when the detection system includes a lidar system). In some aspects, the transmission signal and the reception signal may be ultrasound signals (e.g., when the detection system includes an ultrasound detection system). The transmission signal and the reception signal may be FMCW signals (e.g., FMCW radar signals), unmodulated continuous wave signals (e.g., unmodulated continuous wave radar signals), pulsed signals (e.g., pulsed radar signals), or the like.

In some aspects, responsive to detecting the occurrence of the event and/or activating the detection system, the user device may refrain from activating (e.g., illuminating) a display of the user device. For example, without the use of the detection system described herein, the user device may activate the display upon the occurrence of the event to present a user interface with controls associated with the event (e.g., upon activation of an alarm, the user device may present a user interface that includes a control to stop the alarm). However, because the detection system facilitates the use of gestures to control a function of the user device, as described herein, the user interface may not be needed. Refraining from activating the display may conserve power and extend a battery life of the user device.

As shown in FIG. 3C, and by reference number 315, the user device may detect a presence of an object (e.g., a non-stationary object, such as the user of the user device). For example, the user device may detect the presence of the object using at least the reception signal (e.g., using a signal resulting from mixing of the transmission signal and the reception signal). In some aspects, the user device may determine a distance of the object based at least in part on a frequency difference between the transmission signal and the reception signal (e.g., based at least in part on a frequency of the signal resulting from mixing of the transmission signal and the reception signal). The user device may determine the distance at a plurality of time points to determine that the distance of the object changes over time, to thereby detect the presence of the object.

As shown in FIG. 3D, and by reference number 320, the user device may determine a characteristic of a movement of the object. For example, the user device may determine the characteristic of the movement of the object using at least the reception signal (e.g., using a signal resulting from mixing of the transmission signal and the reception signal). The characteristic of the movement may be velocities of the movement. In some aspects, to determine the characteristic of the movement, the user device may perform range Doppler spectrum post-processing to measure the velocities in sign and magnitude of the object. In other words, the object's displacement over time may induce a variation in the frequency of the reception signal, referred to as a Doppler frequency, proportional to the velocity of the object. Thus, to determine the characteristic of the movement, the user device may determine Doppler frequencies at a plurality of time points using at least the reception signal (e.g., using a signal resulting from mixing of the transmission signal and the reception signal), and the user device may determine velocities of the object at the plurality of time points in accordance with the Doppler frequencies. For example, Doppler frequency (fa) may be represented by Equation 1:

$${f}_{d} = v \cdot \frac{{F}_{c}}{c} \qquad Equation 1$$

where v is the velocity of a target, Fc is the carrier frequency of the transmission signal (e.g., an FMCW pulse), and c is the speed of light constant. A negative velocity value may indicate that the object is approaching the user device along a radial direction, and a positive velocity value may indicate that the object is moving away from the user device along a radial direction.

As shown in FIG. 3E, and by reference number 325, the user device may determine whether the characteristic of the movement (e.g., the velocities) of the object is indicative of a gesture. The gesture may be a hand movement (e.g., a horizontal hand movement) toward or away from the user device or another identifiable movement of a human body. Moreover, the gesture may be designated for controlling a particular function of the user device. In other words, the user device may be configured to control the function in a particular manner when the gesture is detected by the user device. In some aspects, the user device may identify the gesture in accordance with a sign of the velocities of the object. For example, as described above, a negative velocity value may indicate that the object is approaching the user device (e.g., the user's hand is approaching the user device), which may correspond to a first gesture that can be identified by the user device. As another example, as described above, a positive velocity value may indicate that the object is moving away from the user device (e.g., the user's hand is moving away from the user device), which may correspond to a second gesture that can be identified by the user device. Each gesture that can be identified by the user device may be designated for controlling a respective function of the user device, and/or may be designated for differently controlling the same function of the user device.

In some aspects, to determine that the characteristic (e.g., the velocities) of the movement of the object is indicative of the gesture, the user device may determine that variations in the velocities across multiple consecutive time points (e.g., two time points, three time points, four time points, or the like), of the plurality of time points, satisfy a variation threshold, and the user device may determine that the velocities of the object are indicative of the gesture responsive to the variations satisfying the variation threshold. For example, when intended as a gesture, the user's hand may approach the user device at an approximately constant velocity (e.g., over multiple time points), and thus the variations in the velocities would be small and satisfy the variation threshold. In contrast, movements of the user's hand, or other body parts, that are not intended as a gesture may approach the user device with inconsistent velocities, and thus the variations in the velocities would be large and not satisfy the variation threshold. In this way, the user device may differentiate intended gestures from arbitrary movements.

In some aspects, to determine that the velocities of the object are indicative of the gesture, the user device may determine that the velocities of the object are indicative of a first gesture responsive to the variations satisfying the threshold and values of the velocities being negative. In some aspects, to determine that the velocities of the object are indicative of the gesture, the user device may determine that the velocities of the object are indicative of a second gesture responsive to the variations satisfying the threshold and the values of the velocities being positive. The variations in the velocities may be represented by a root mean square error (RMSE), a mean square error (MSE), a root mean square deviation (RMSD), a standard deviation, or the like. For example, an RMSE of about zero may indicate a relatively constant velocity.

As shown in FIG. 3F, plot 330 and plot 335 provide an example of using variations in velocities to identify a gesture. Plot 330 shows the velocities over time of a first movement of the user that is intended as a gesture (e.g., movement of the user's hand toward the user device) and the velocities over time of a second movement (e.g., an arbitrary movement) of the user that is not intended as a gesture (e.g., the user stretching or yawning). As plot 330 shows, the first movement is associated with a consistent velocity pattern, while the second movement is associated with an inconsistent velocity pattern. Plot 335 shows the RMSE for the velocities over time of plot 330 and shows a variation threshold. For the first movement, plot 335 shows that the RMSE is below the threshold for four consecutive time points, thereby indicating that the first movement is a gesture. For the second movement, plot 335 shows that the RMSE is not below the threshold at any time point, thereby indicating that the second movement is not a gesture. The RMSE at a sample n may be calculated according to Equation 2:

$$ξ ( n ) = \sqrt{} ( \frac{1}{k} {\sum }_{i = n - k}^{n} {\vert v ( i ) - v ( i - 1 ) \vert}^{2} ) \qquad Equation 2$$

where k is a quantity of samples (e.g., a sliding window of 3 samples), v(i) is a velocity at a current sample i, and v(i−1) is a velocity at a preceding sample of the current sample i.

Using the detection system, the user device may detect the object and determine the characteristic of the movement of the object when the object is positioned to a front, a back, and/or a side of the user device. In contrast, in order for a camera of the user device to detect and track an object, the object needs to be in a field of view of the camera. Thus, the camera may be unable to sufficiently determine a characteristic of a movement of an object when the object is not in the field of view of the camera or when the object moves in and out of the field of view of the camera. In this way, some aspects described herein provide improved object detection and tracking and improved gesture recognition.

As shown in FIG. 3G, and by reference number 340, the user device may control the function of the user device. For example, the user device may control the function of the user device responsive to determining that the characteristic (e.g., the velocities) of the movement of the object is indicative of the gesture. As an example, the user device may control a function in a first manner, or control a first function, responsive to determining that the velocities are indicative of a first gesture. As another example, the user device may control the function in a second manner, or control a second function, responsive to determining that the velocities are indicative of a second gesture.

In some aspects, to control the function of the user device, the user device may deactivate an alarm of the user device (e.g., when the event that occurred was an alarm of the user device activating). For example, detection of the object approaching the user device at an approximately constant velocity may indicate a gesture of the user's hand approaching the user device, and that gesture may be designated for deactivating an alarm. Deactivating the alarm may include stopping the alarm, snoozing the alarm, or resetting the alarm. In some aspects, to control the function of the user device, the user device may silence a ringtone of the user device (e.g., when the event that occurred was an incoming call or message to the user device). In some aspects, to control the function of the user device, the user device may decline an incoming call to the user device (e.g., when the event that occurred was an incoming call to the user device). For example, to decline the incoming call, the user device may transfer the incoming call to a voicemail. In some aspects, to control the function of the user device, the user device may adjust a volume of the user device (e.g., when the event that occurred was media playing on the user device). In some aspects, to control the function of the user device, the user device may alter playback of media on the user device. Altering the playback may include stopping the playback, starting the playback, rewinding the playback, fast-forwarding the playback, or the like.

Gesture control of the function of the user device may facilitate faster control of the function relative to control through a user interface presented on the display of the user device. Accordingly, the gesture control may reduce an amount of time that the display of the user device is illuminated, thereby conserving power and extending a battery life of the user device. In aspects in which the user device may refrain from activating the display of the user device when the detection system is being used to detect the gesture, significant power savings may be achieved.

As indicated above, FIGS. 3A-3G are provided as an example. Other examples may differ from what is described with respect to FIGS. 3A-3G.

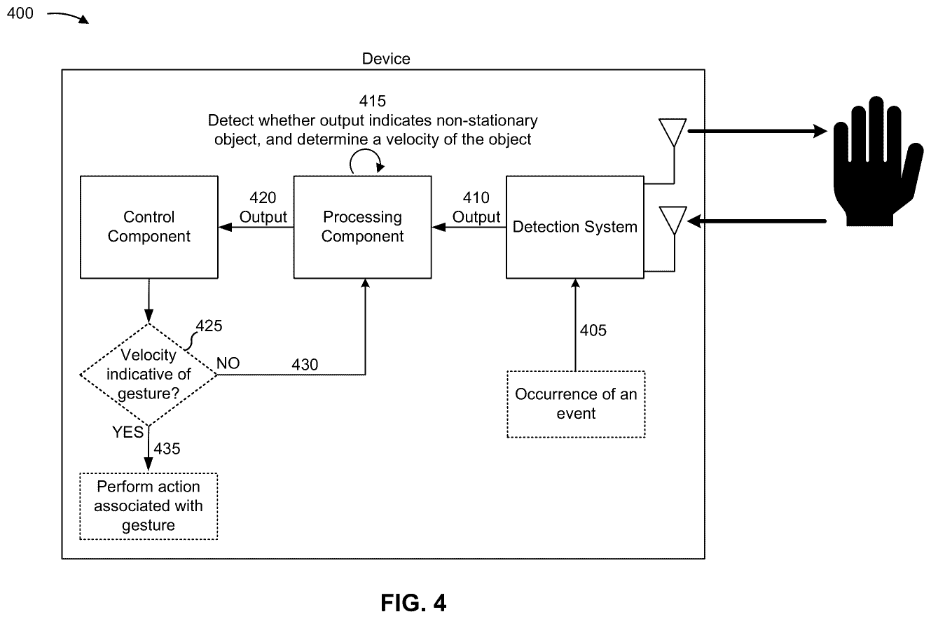

FIG. 4 is a diagram illustrating an example 400 associated with gesture control of a device, in accordance with the present disclosure. The device shown in FIG. 4 may correspond to the user device described herein.

As described above, the device may include a detection system, such as a radar system (e.g., an FMCW radar system). For example, the detection system may include radio frequency (RF) components and multiple antennas for signal transmission and reception. As shown by reference number 405, and as described above, the device may activate the detection system (e.g., activate the radar system) responsive to an occurrence of an event (e.g., activation of an alarm of the device), which may cause initiation of signal transmission and reception at the detection component. In some aspects, the detection system (e.g., using the RF components) may process a signal by performing filtering of the signal, amplification of the signal, or the like.

The device may include a processing component, such as a radar processing component, configured to process signals received at the receiver of the detection system. As shown by reference number 410, the processing component may receive an output of the detection system. For example, the output of the detection system may be a reception signal received at the detection system (e.g., following any processing of the reception signal). As another example, the output of the detection system may be a signal resulting from mixing of the reception signal and the transmission signal (e.g., following any processing of the signal). As shown by reference number 415, and as described above, the processing component may detect whether the output of the detection system indicates a non-stationary object, and the processing component may determine velocities of the object.

The device may include a control component configured to control functions of the device (e.g., in accordance with an output of the processing component). As shown by reference number 420, the control component may receive an output of the processing component. For example, the output of the processing component may indicate the velocities of the object. As shown by reference number 425, and as described above, the control component may determine, using the output of the processing component, whether the velocities of the object are indicative of a gesture. For example, the velocities being negative and relatively constant may indicate a gesture of a hand approaching the device.

As shown by reference number 430, if the velocities of the object are not indicative of the gesture, then the control component may refrain from performing an action associated with the gesture, and the processing component may continue to monitor for non-stationary objects. As shown by reference number 435, if the velocities of the object are indicative of the gesture, then the control component may perform the action associated with the gesture. For example, the action may be deactivating an alarm of the device. In some aspects, the processing component and/or the control component may be included in the detection system.

As indicated above, FIG. 4 is provided as an example. Other examples may differ from what is described with respect to FIG. 4.

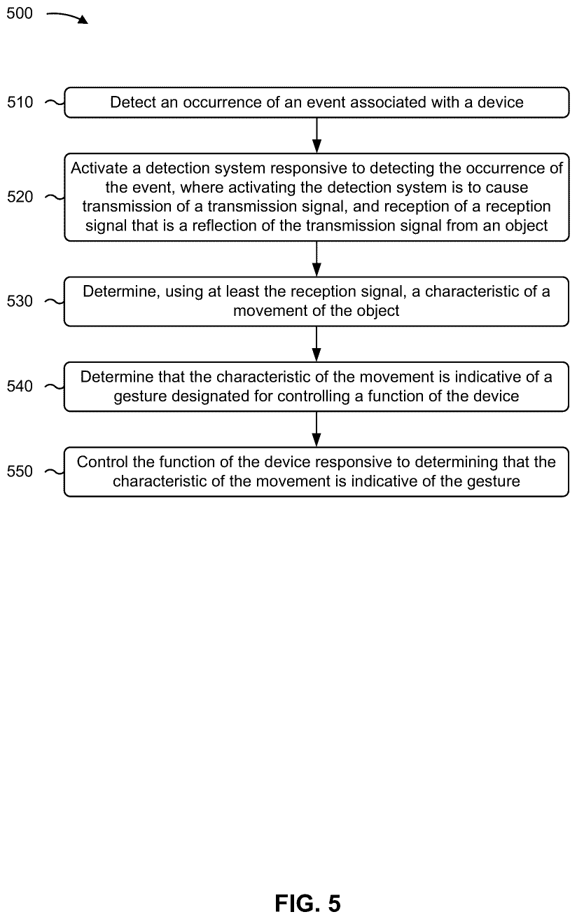

FIG. 5 is a flowchart of an example process 500 associated with gesture control of a device. In some aspects, one or more process blocks of FIG. 5 are performed by a device (e.g., user device 110). In some aspects, one or more process blocks of FIG. 5 are performed by another device or a group of devices separate from or including the device, such as a communication device (e.g., communication device 120).

Additionally, or alternatively, one or more process blocks of FIG. 5 may be performed by one or more components of device 200, such as processor 210, memory 215, storage component 220, input component 225, output component 230, communication interface 235, and/or sensor(s) 240.

As shown in FIG. 5, process 500 may include detecting an occurrence of an event associated with a device (block 510). For example, the device may detect an occurrence of an event associated with the device, as described above.

As further shown in FIG. 5, process 500 may include activating a detection system responsive to detecting the occurrence of the event, where activating the detection system is to cause transmission of a transmission signal, and reception of a reception signal that is a reflection of the transmission signal from an object (block 520). For example, the device may activate the detection system responsive to detecting the occurrence of the event. In some aspects, activating the detection system is to cause transmission of a transmission signal, and reception of a reception signal that is a reflection of the transmission signal from an object.

As further shown in FIG. 5, process 500 may include determining, using at least the reception signal, a characteristic of a movement of the object (block 530). For example, the device may determine, using at least the reception signal, a characteristic of a movement of the object, as described above.

As further shown in FIG. 5, process 500 may include determining that the characteristic of the movement is indicative of a gesture designated for controlling a function of the device (block 540). For example, the device may determine that the characteristic of the movement is indicative of a gesture designated for controlling a function of the device, as described above.

As further shown in FIG. 5, process 500 may include controlling the function of the device responsive to determining that the characteristic of the movement is indicative of the gesture (block 550). For example, the device may control the function of the device responsive to determining that the characteristic of the movement is indicative of the gesture, as described above.

Process 500 may include additional aspects, such as any single aspect or any combination of aspects described below and/or in connection with one or more other processes described elsewhere herein.

In a first aspect, the event includes at least one of activation of an alarm of the device, an incoming call to the device, or media playing on the device.

In a second aspect, alone or in combination with the first aspect, the detection system includes a radar system, a lidar system, or an ultrasound detection system.

In a third aspect, alone or in combination with one or more of the first and second aspects, the transmission signal is a frequency modulated continuous wave signal or an unmodulated continuous wave signal.

In a fourth aspect, alone or in combination with one or more of the first through third aspects, the characteristic of the movement is velocities of the movement.

In a fifth aspect, alone or in combination with one or more of the first through fourth aspects, determining the characteristic of the movement includes determining Doppler frequencies at a plurality of time points using at least the reception signal, and determining velocities of the object at the plurality of time points in accordance with the Doppler frequencies.

In a sixth aspect, alone or in combination with one or more of the first through fifth aspects, determining that the characteristic of the movement is indicative of the gesture includes determining that variations in the velocities across multiple consecutive time points, of the plurality of time points, satisfy a threshold, and determining that the velocities of the object are indicative of the gesture responsive to the variations satisfying the threshold.

In a seventh aspect, alone or in combination with one or more of the first through sixth aspects, determining that the velocities of the object are indicative of the gesture includes determining that the velocities of the object are indicative of a first gesture responsive to the variations satisfying the threshold and values of the velocities being negative, or a second gesture responsive to the variations satisfying the threshold and the values of the velocities being positive.

In an eighth aspect, alone or in combination with one or more of the first through seventh aspects, controlling the function of the device includes deactivating an alarm of the device, silencing a ringtone of the device, declining an incoming call to the device, or adjusting a volume of the device.

In a ninth aspect, alone or in combination with one or more of the first through eighth aspects, the gesture is a hand movement toward or away from the device.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

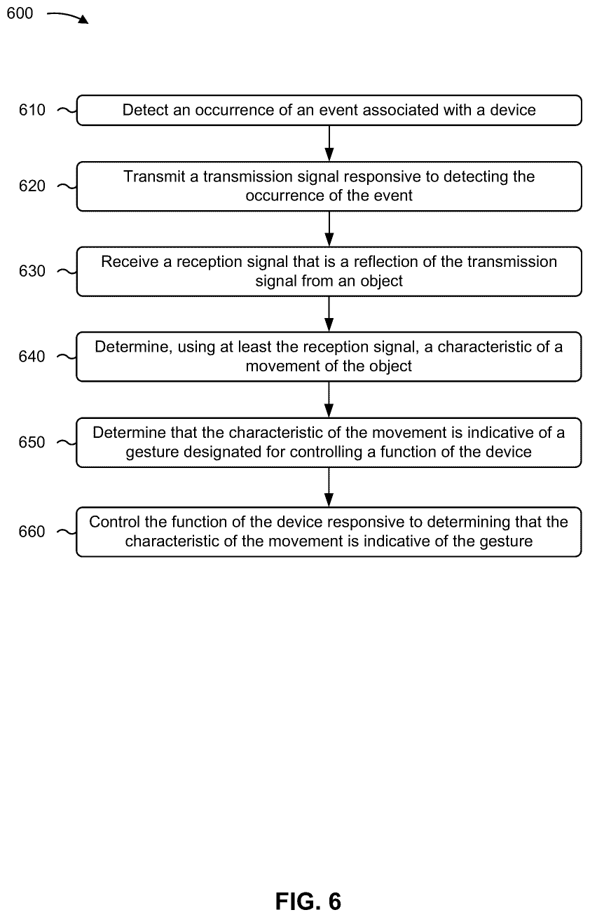

FIG. 6 is a flowchart of an example process 600 associated with gesture control of a device. In some aspects, one or more process blocks of FIG. 6 are performed by a device (e.g., user device 110). In some aspects, one or more process blocks of FIG. 6 are performed by another device or a group of devices separate from or including the device, such as a communication device (e.g., communication device 120).

Additionally, or alternatively, one or more process blocks of FIG. 6 may be performed by one or more components of device 200, such as processor 210, memory 215, storage component 220, input component 225, output component 230, communication interface 235, and/or sensor(s) 240.

As shown in FIG. 6, process 600 may include detecting an occurrence of an event associated with a device (block 610). For example, the device may detect an occurrence of an event associated with the device, as described above.

As further shown in FIG. 6, process 600 may include transmitting a transmission signal responsive to detecting the occurrence of the event (block 620). For example, the device may transmit a transmission signal responsive to detecting the occurrence of the event, as described above.

As further shown in FIG. 6, process 600 may include receiving a reception signal that is a reflection of the transmission signal from an object (block 630). For example, the device may receive a reception signal that is a reflection of the transmission signal from an object, as described above.

As further shown in FIG. 6, process 600 may include determining, using at least the reception signal, a characteristic of a movement of the object (block 640). For example, the device may determine, using at least the reception signal, a characteristic of a movement of the object, as described above.

As further shown in FIG. 6, process 600 may include determining that the characteristic of the movement is indicative of a gesture designated for controlling a function of the device (block 650). For example, the device may determine that the characteristic of the movement is indicative of a gesture designated for controlling a function of the device, as described above.

As further shown in FIG. 6, process 600 may include controlling the function of the device responsive to determining that the characteristic of the movement is indicative of the gesture (block 660). For example, the device may control the function of the device responsive to determining that the characteristic of the movement is indicative of the gesture, as described above.

Process 600 may include additional aspects, such as any single aspect or any combination of aspects described below and/or in connection with one or more other processes described elsewhere herein.

In a first aspect, the event includes at least one of activation of an alarm of the device, an incoming call to the device, or media playing on the device.

In a second aspect, alone or in combination with the first aspect, the transmission signal includes a radio signal, an optical signal, or an ultrasound signal.

In a third aspect, alone or in combination with one or more of the first and second aspects, the transmission signal is a frequency modulated continuous wave signal or an unmodulated continuous wave signal.

In a fourth aspect, alone or in combination with one or more of the first through third aspects, the characteristic of the movement is velocities of the movement.

In a fifth aspect, alone or in combination with one or more of the first through fourth aspects, determining the characteristic of the movement includes determining Doppler frequencies at a plurality of time points using at least the reception signal, and determining velocities of the object at the plurality of time points in accordance with the Doppler frequencies.

In a sixth aspect, alone or in combination with one or more of the first through fifth aspects, determining that the characteristic of the movement is indicative of the gesture includes determining that variations in the velocities across multiple consecutive time points, of the plurality of time points, satisfy a threshold, and determining that the velocities of the object are indicative of the gesture responsive to the variations satisfying the threshold.

In a seventh aspect, alone or in combination with one or more of the first through sixth aspects, determining that the velocities of the object are indicative of the gesture includes determining that the velocities of the object are indicative of a first gesture responsive to the variations satisfying the threshold and values of the velocities being negative, or a second gesture responsive to the variations satisfying the threshold and the values of the velocities being positive.

In an eighth aspect, alone or in combination with one or more of the first through seventh aspects, controlling the function of the device includes deactivating an alarm of the device, silencing a ringtone of the device, declining an incoming call to the device, or adjusting a volume of the device.

In a ninth aspect, alone or in combination with one or more of the first through eighth aspects, the gesture is a hand movement toward or away from the device.

Although FIG. 6 shows example blocks of process 600, in some aspects, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:
Aspect 1: A device, comprising: a detection system; one or more memories; and one or more processors, coupled to the one or more memories, configured to: detect an occurrence of an event associated with the device; activate the detection system responsive to detecting the occurrence of the event, wherein activating the detection system is to cause transmission of a transmission signal, and reception of a reception signal that is a reflection of the transmission signal from an object; determine, using at least the reception signal, a characteristic of a movement of the object; determine that the characteristic of the movement is indicative of a gesture designated for controlling a function of the device; and control the function of the device responsive to determining that the characteristic of the movement is indicative of the gesture.
Aspect 2: The device of Aspect 1, wherein the event comprises at least one of: activation of an alarm of the device, an incoming call to the device, or media playing on the device.
Aspect 3: The device of any of Aspects 1-2, wherein the detection system comprises: a radar system, a lidar system, or an ultrasound detection system.
Aspect 4: The device of any of Aspects 1-3, wherein the transmission signal is a frequency modulated continuous wave signal or an unmodulated continuous wave signal.
Aspect 5: The device of any of Aspects 1-4, wherein the characteristic of the movement is velocities of the movement.
Aspect 6: The device of any of Aspects 1-5, wherein the one or more processors, to determine the characteristic of the movement, are configured to: determine Doppler frequencies at a plurality of time points using at least the reception signal; and determine velocities of the object at the plurality of time points in accordance with the Doppler frequencies.
Aspect 7: The device of Aspect 6, wherein the one or more processors, to determine that the characteristic of the movement is indicative of the gesture, are configured to: determine that variations in the velocities across multiple consecutive time points, of the plurality of time points, satisfy a threshold; and determine that the velocities of the object are indicative of the gesture responsive to the variations satisfying the threshold.
Aspect 8: The device of Aspect 7, wherein the one or more processors, to determine that the velocities of the object are indicative of the gesture, are configured to: determine that the velocities of the object are indicative of a first gesture responsive to the variations satisfying the threshold and values of the velocities being negative, or a second gesture responsive to the variations satisfying the threshold and the values of the velocities being positive.
Aspect 9: The device of any of Aspects 1-8, wherein the one or more processors, to control the function of the device, are configured to: deactivate an alarm of the device, silence a ringtone of the device, decline an incoming call to the device, or adjust a volume of the device.
Aspect 10: The device of any of Aspects 1-9, wherein the gesture is a hand movement toward or away from the device.
Aspect 11: A method, comprising: detecting, by a device, an occurrence of an event associated with the device; transmitting, by the device, a transmission signal responsive to detecting the occurrence of the event; receiving, by the device, a reception signal that is a reflection of the transmission signal from an object; determining, by the device and using at least the reception signal, a characteristic of a movement of the object; determining, by the device, that the characteristic of the movement is indicative of a gesture designated for controlling a function of the device; and controlling, by the device, the function of the device responsive to determining that the characteristic of the movement is indicative of the gesture.
Aspect 12: The method of Aspect 11, wherein the event comprises at least one of: activation of an alarm of the device, an incoming call to the device, or media playing on the device.
Aspect 13: The method of any of Aspects 11-12, wherein the transmission signal comprises: a radio signal, an optical signal, or an ultrasound signal.
Aspect 14: The method of any of Aspects 11-13, wherein the transmission signal is a frequency modulated continuous wave signal or an unmodulated continuous wave signal.
Aspect 15: The method of any of Aspects 11-14, wherein the characteristic of the movement is velocities of the movement.
Aspect 16: The method of any of Aspects 11-15, wherein determining the characteristic of the movement comprises: determining Doppler frequencies at a plurality of time points using at least the reception signal; and determining velocities of the object at the plurality of time points in accordance with the Doppler frequencies.
Aspect 17: The method of Aspect 16, wherein determining that the characteristic of the movement is indicative of the gesture comprises: determining that variations in the velocities across multiple consecutive time points, of the plurality of time points, satisfy a threshold; and determining that the velocities of the object are indicative of the gesture responsive to the variations satisfying the threshold.
Aspect 18: The method of Aspect 17, wherein determining that the velocities of the object are indicative of the gesture comprises: determining that the velocities of the object are indicative of a first gesture responsive to the variations satisfying the threshold and values of the velocities being negative, or a second gesture responsive to the variations satisfying the threshold and the values of the velocities being positive.
Aspect 19: The method of any of Aspects 11-18, wherein controlling the function of the device comprises: deactivating an alarm of the device, silencing a ringtone of the device, declining an incoming call to the device, or adjusting a volume of the device.
Aspect 20: The method of any of Aspects 11-19, wherein the gesture is a hand movement toward or away from the device.
Aspect 21: A non-transitory computer-readable medium storing a set of instructions, the set of instructions comprising: one or more instructions that, when executed by one or more processors of a device, cause the device to: detect an occurrence of an event associated with the device; activate a detection system responsive to detecting the occurrence of the event, wherein activating the detection system is to cause transmission of a transmission signal, and reception of a reception signal that is a reflection of the transmission signal from an object; determine, using at least the reception signal, a characteristic of a movement of the object; determine that the characteristic of the movement is indicative of a gesture designated for controlling a function of the device; and control the function of the device responsive to determining that the characteristic of the movement is indicative of the gesture.
Aspect 22: The non-transitory computer-readable medium of Aspect 21, wherein the event comprises at least one of: activation of an alarm of the device, an incoming call to the device, or media playing on the device.
Aspect 23: The non-transitory computer-readable medium of any of Aspects 21-22, wherein the detection system comprises: a radar system, a lidar system, or an ultrasound detection system.
Aspect 24: The non-transitory computer-readable medium of any of Aspects 21-23, wherein the one or more instructions, that cause the device to determine the characteristic of the movement, cause the device to: determine Doppler frequencies at a plurality of time points using at least the reception signal; and determine velocities of the object at the plurality of time points in accordance with the Doppler frequencies.
Aspect 25: The non-transitory computer-readable medium of Aspect 24, wherein the one or more instructions, that cause the device to determine that the characteristic of the movement is indicative of the gesture, cause the device to: determine that variations in the velocities across multiple consecutive time points, of the plurality of time points, satisfy a threshold; and determine that the velocities of the object are indicative of the gesture responsive to the variations satisfying the threshold.
Aspect 26: The non-transitory computer-readable medium of any of Aspects 21-25, wherein the one or more instructions, that cause the device to control the function of the device, cause the device to: deactivate an alarm of the device, silence a ringtone of the device, decline an incoming call to the device, or adjust a volume of the device.
Aspect 27: An apparatus, comprising: means for detecting an occurrence of an event; means for transmitting a transmission signal responsive to detecting the occurrence of the event; means for receiving a reception signal that is a reflection of the transmission signal from an object; means for determining, using at least the reception signal, a characteristic of a movement of the object; means for determining that the characteristic of the movement is indicative of a gesture designated for controlling a function; and means for controlling the function responsive to determining that the characteristic of the movement is indicative of the gesture.
Aspect 28: The apparatus of Aspect 27, wherein the means for determining the characteristic of the movement comprises: means for determining Doppler frequencies at a plurality of time points using at least the reception signal; and means for determining velocities of the object at the plurality of time points in accordance with the Doppler frequencies.
Aspect 29: The apparatus of Aspect 28, wherein the means for determining that the characteristic of the movement is indicative of the gesture comprises: means for determining that variations in the velocities across multiple consecutive time points, of the plurality of time points, satisfy a threshold; and means for determining that the velocities of the object are indicative of the gesture responsive to the variations satisfying the threshold.
Aspect 30: The apparatus of Aspect 29, wherein the means for determining that the velocities of the object are indicative of the gesture comprises: means for determining that the velocities of the object are indicative of a first gesture responsive to the variations satisfying the threshold and values of the velocities being negative, or a second gesture responsive to the variations satisfying the threshold and the values of the velocities being positive.
Aspect 31: A system configured to perform one or more operations recited in one or more of Aspects 1-10.
Aspect 32: An apparatus comprising means for performing one or more operations recited in one or more of Aspects 1-10.
Aspect 33: A non-transitory computer-readable medium storing a set of instructions, the set of instructions comprising one or more instructions that, when executed by a device, cause the device to perform one or more operations recited in one or more of Aspects 1-10.
Aspect 34: A computer program product comprising instructions or code for executing one or more operations recited in one or more of Aspects 1-10.
Aspect 35: A method comprising one or more operations recited in one or more of Aspects 1-10.
Aspect 36: A system configured to perform one or more operations recited in one or more of Aspects 11-20.
Aspect 37: An apparatus comprising means for performing one or more operations recited in one or more of Aspects 11-20.
Aspect 38: A non-transitory computer-readable medium storing a set of instructions, the set of instructions comprising one or more instructions that, when executed by a device, cause the device to perform one or more operations recited in one or more of Aspects 11-20.
Aspect 39: A computer program product comprising instructions or code for executing one or more operations recited in one or more of Aspects 11-20.
Aspect 40: A system configured to perform one or more operations recited in one or more of Aspects 21-26.
Aspect 41: An apparatus comprising means for performing one or more operations recited in one or more of Aspects 21-26.
Aspect 42: A non-transitory computer-readable medium storing a set of instructions, the set of instructions comprising one or more instructions that, when executed by a device, cause the device to perform one or more operations recited in one or more of Aspects 21-26.
Aspect 43: A computer program product comprising instructions or code for executing one or more operations recited in one or more of Aspects 21-26.
Aspect 44: A method comprising one or more operations recited in one or more of Aspects 21-26.
Aspect 45: A system configured to perform one or more operations recited in one or more of Aspects 27-30.
Aspect 46: A non-transitory computer-readable medium storing a set of instructions, the set of instructions comprising one or more instructions that, when executed by a device, cause the device to perform one or more operations recited in one or more of Aspects 27-30.
Aspect 47: A computer program product comprising instructions or code for executing one or more operations recited in one or more of Aspects 27-30.
Aspect 48: A method comprising one or more operations recited in one or more of Aspects 27-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device, comprising:
a detection system;
one or more memories; and
one or more processors, coupled to the one or more memories, configured to:
detect an occurrence of an event associated with the device;
activate the detection system responsive to detecting the occurrence of the event,
wherein activating the detection system is to cause transmission of a transmission signal, and reception of a reception signal that is a reflection of the transmission signal from an object;
determine, using at least the reception signal, a characteristic of a movement of the object;
determine that the characteristic of the movement is indicative of a gesture designated for controlling a function of the device; and
control the function of the device responsive to determining that the characteristic of the movement is indicative of the gesture.

2. The device of claim Error! Reference source not found., wherein the event comprises at least one of:
activation of an alarm of the device,
an incoming call to the device, or
media playing on the device.

3. The device of claim Error! Reference source not found., wherein the detection system comprises:
a radar system,
a lidar system, or
an ultrasound detection system.

4. The device of claim Error! Reference source not found., wherein the transmission signal is a frequency modulated continuous wave signal or an unmodulated continuous wave signal.

5. The device of claim Error! Reference source not found., wherein the characteristic of the movement is velocities of the movement.

6. The device of claim Error! Reference source not found., wherein the one or more processors, to determine the characteristic of the movement, are configured to:
determine Doppler frequencies at a plurality of time points using at least the reception signal; and
determine velocities of the object at the plurality of time points in accordance with the Doppler frequencies.

7. The device of claim Error! Reference source not found., wherein the one or more processors, to determine that the characteristic of the movement is indicative of the gesture, are configured to:
determine that variations in the velocities across multiple consecutive time points, of the plurality of time points, satisfy a threshold; and
determine that the velocities of the object are indicative of the gesture responsive to the variations satisfying the threshold.

8. The device of claim 7, wherein the one or more processors, to determine that the velocities of the object are indicative of the gesture, are configured to:
determine that the velocities of the object are indicative of a first gesture responsive to the variations satisfying the threshold and values of the velocities being negative, or a second gesture responsive to the variations satisfying the threshold and the values of the velocities being positive.

9. The device of claim Error! Reference source not found., wherein the one or more processors, to control the function of the device, are configured to:
deactivate an alarm of the device,
silence a ringtone of the device,
decline an incoming call to the device, or
adjust a volume of the device.

10. The device of claim Error! Reference source not found., wherein the gesture is a hand movement toward or away from the device.

11. A method, comprising:
detecting, by a device, an occurrence of an event associated with the device;
transmitting, by the device, a transmission signal responsive to detecting the occurrence of the event;
receiving, by the device, a reception signal that is a reflection of the transmission signal from an object;
determining, by the device and using at least the reception signal, a characteristic of a movement of the object;
determining, by the device, that the characteristic of the movement is indicative of a gesture designated for controlling a function of the device; and
controlling, by the device, the function of the device responsive to determining that the characteristic of the movement is indicative of the gesture.

12. The method of claim 11, wherein the event comprises at least one of:
activation of an alarm of the device,
an incoming call to the device, or
media playing on the device.

13. The method of claim 11, wherein the transmission signal comprises:
a radio signal,
an optical signal, or
an ultrasound signal.

14. The method of claim 11, wherein the transmission signal is a frequency modulated continuous wave signal or an unmodulated continuous wave signal.

15. The method of claim 11, wherein the characteristic of the movement is velocities of the movement.

16. The method of claim 11, wherein determining the characteristic of the movement comprises:
determining Doppler frequencies at a plurality of time points using at least the reception signal; and
determining velocities of the object at the plurality of time points in accordance with the Doppler frequencies.

17. The method of claim 16, wherein determining that the characteristic of the movement is indicative of the gesture comprises:
determining that variations in the velocities across multiple consecutive time points, of the plurality of time points, satisfy a threshold; and
determining that the velocities of the object are indicative of the gesture responsive to the variations satisfying the threshold.

18. The method of claim 17, wherein determining that the velocities of the object are indicative of the gesture comprises:
determining that the velocities of the object are indicative of a first gesture responsive to the variations satisfying the threshold and values of the velocities being negative, or a second gesture responsive to the variations satisfying the threshold and the values of the velocities being positive.

19. The method of claim 11, wherein controlling the function of the device comprises:
deactivating an alarm of the device,
silencing a ringtone of the device,
declining an incoming call to the device, or
adjusting a volume of the device.

20. The method of claim 11, wherein the gesture is a hand movement toward or away from the device.

21. A non-transitory computer-readable medium storing a set of instructions, the set of instructions comprising:
one or more instructions that, when executed by one or more processors of a device, cause the device to:
detect an occurrence of an event associated with the device;
activate a detection system responsive to detecting the occurrence of the event,
wherein activating the detection system is to cause transmission of a transmission signal, and reception of a reception signal that is a reflection of the transmission signal from an object;
determine, using at least the reception signal, a characteristic of a movement of the object;
determine that the characteristic of the movement is indicative of a gesture designated for controlling a function of the device; and
control the function of the device responsive to determining that the characteristic of the movement is indicative of the gesture.

22. The non-transitory computer-readable medium of claim Error! Reference source not found., wherein the event comprises at least one of:
activation of an alarm of the device,
an incoming call to the device, or
media playing on the device.

23. The non-transitory computer-readable medium of claim Error! Reference source not found., wherein the detection system comprises:
a radar system,
a lidar system, or
an ultrasound detection system.

24. The non-transitory computer-readable medium of claim Error! Reference source not found., wherein the one or more instructions, that cause the device to determine the characteristic of the movement, cause the device to:
determine Doppler frequencies at a plurality of time points using at least the reception signal; and
determine velocities of the object at the plurality of time points in accordance with the Doppler frequencies.

25. The non-transitory computer-readable medium of claim Error! Reference source not found., wherein the one or more instructions, that cause the device to determine that the characteristic of the movement is indicative of the gesture, cause the device to:
determine that variations in the velocities across multiple consecutive time points, of the plurality of time points, satisfy a threshold; and
determine that the velocities of the object are indicative of the gesture responsive to the variations satisfying the threshold.

26. The non-transitory computer-readable medium of claim Error! Reference source not found., wherein the one or more instructions, that cause the device to control the function of the device, cause the device to:
deactivate an alarm of the device,
silence a ringtone of the device,
decline an incoming call to the device, or
adjust a volume of the device.

27. An apparatus, comprising:
means for detecting an occurrence of an event;
means for transmitting a transmission signal responsive to detecting the occurrence of the event;
means for receiving a reception signal that is a reflection of the transmission signal from an object;
means for determining, using at least the reception signal, a characteristic of a movement of the object;
means for determining that the characteristic of the movement is indicative of a gesture designated for controlling a function; and
means for controlling the function responsive to determining that the characteristic of the movement is indicative of the gesture.

28. The apparatus of claim Error! Reference source not found., wherein the means for determining the characteristic of the movement comprises:
means for determining Doppler frequencies at a plurality of time points using at least the reception signal; and
means for determining velocities of the object at the plurality of time points in accordance with the Doppler frequencies.

29. The apparatus of claim Error! Reference source not found., wherein the means for determining that the characteristic of the movement is indicative of the gesture comprises:
means for determining that variations in the velocities across multiple consecutive time points, of the plurality of time points, satisfy a threshold; and
means for determining that the velocities of the object are indicative of the gesture responsive to the variations satisfying the threshold.

30. The apparatus of claim 29, wherein the means for determining that the velocities of the object are indicative of the gesture comprises:
means for determining that the velocities of the object are indicative of a first gesture responsive to the variations satisfying the threshold and values of the velocities being negative, or a second gesture responsive to the variations satisfying the threshold and the values of the velocities being positive.
